(19) United States
(12) Patent Application Publication
(10) Pub. No.: US 2002/0097568 A1
(43) Pub. Date: Jul. 25, 2002

(54) Wall lamp structure with projective clock

(75) Inventor: Wen-Jung Li, Taipei (TW)

Correspondence Address: DOUGHERTY & TROXELL, SUITE 1404, 5205 LEESBURG PIKE, FALLS CHURCH, VA, 22041, US

(73) Assignee: Top Want Ind. Co., Ltd.

(21) Appl. No.: 09/824,797

(22) Filed: Apr. 4, 2001

(30) Foreign Application Priority Data
Jan. 20, 2001 (TW) 90201416

(51) Int. Cl. G01D 11/28

(52) U.S. Cl. 362/23

(57) ABSTRACT

Wall lamp structure with projective clocks including a seat body and a projecting unit connected with the seat body by a connecting member and right positioned above the front face of the seat body. A timer is disposed on the seat body. The projecting unit is a shade body. A light emitter is disposed in the projecting unit, facing the front face of the seat body. A mark member having marks is fitted around the light emitter. The light emitter projects light beam onto the mark member and the indicators of the timer to show the shades thereof on the wall face to form a magnified shade-type clock.

### BACKGROUND OF THE INVENTION

The present invention is related to a wall lamp structure with projective clock, including a projecting unit and a timer. A light emitter of the projecting unit projects light beam onto a mark member and indicators of the timer to show the shades thereof on a wall face. The wall lamp not only serves to create a romantic effect, but also provides a unique shade-type clock.

A conventional wall lamp includes a seat body for mounting on a wall face and a shade body connected with the seat body. A light emitter is disposed in the shade body to project light beam onto the wall face so as to achieve a romantic atmosphere and decorative effect. However, such wall lamp lacks any other practical usage. On the other hand, a conventional clock has monotonous appearance and can hardly present any visually novel pattern.

### SUMMARY OF THE INVENTION

It is therefore a primary object of the present invention to provide a wall lamp structure with projective clock. The wall lamp includes a seat body for mounting on a plane face or wall face and a projecting unit connected with and right positioned above the front face of the seat body. A timer is disposed on the seat body. The projecting unit is a shade body. A light emitter is disposed in the projecting unit, facing the front face of the seat body. A mark member having marks is fitted around the light emitter. The light emitter projects light beam onto the mark member and the indicators of the timer to show the shades thereof on the wall face to form a magnified shade-type clock.

The present invention can be best understood through the following description and accompanying drawings wherein:

### BRIEF DESCRIPTION OF THE DRAWINGS

FIG. 1 is a perspective exploded view of the wall lamp structure of the present invention;

FIG. 2 is a perspective assembled view of the wall lamp structure of the present invention; and

FIG. 3 shows the projection of light of the wall lamp structure of the present invention.

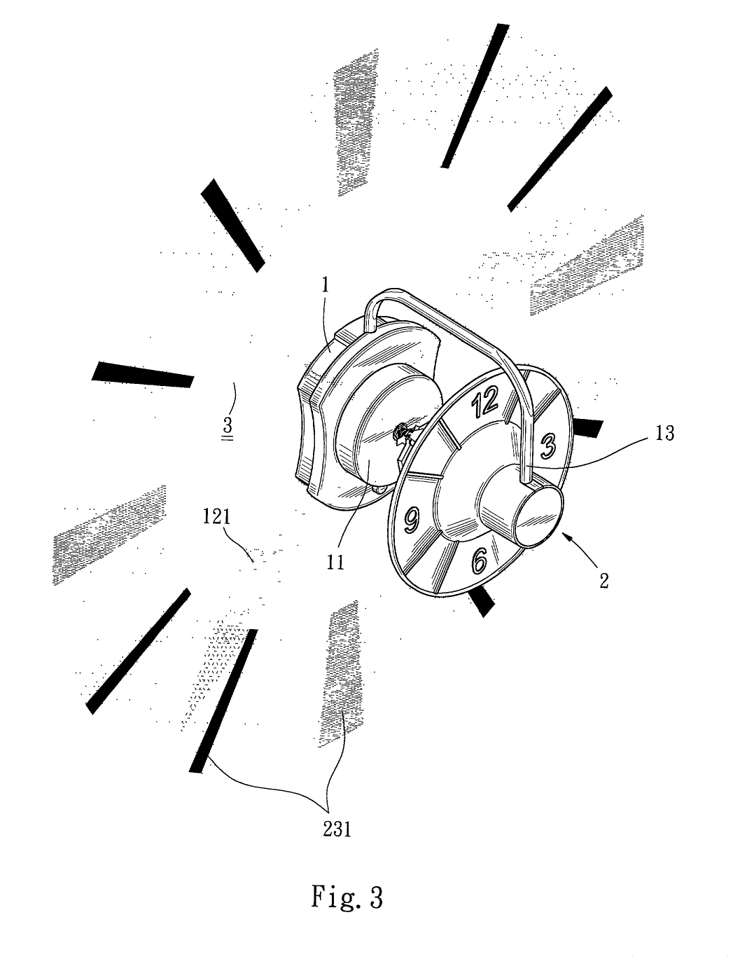

### DETAILED DESCRIPTION OF THE PREFERRED EMBODIMENT

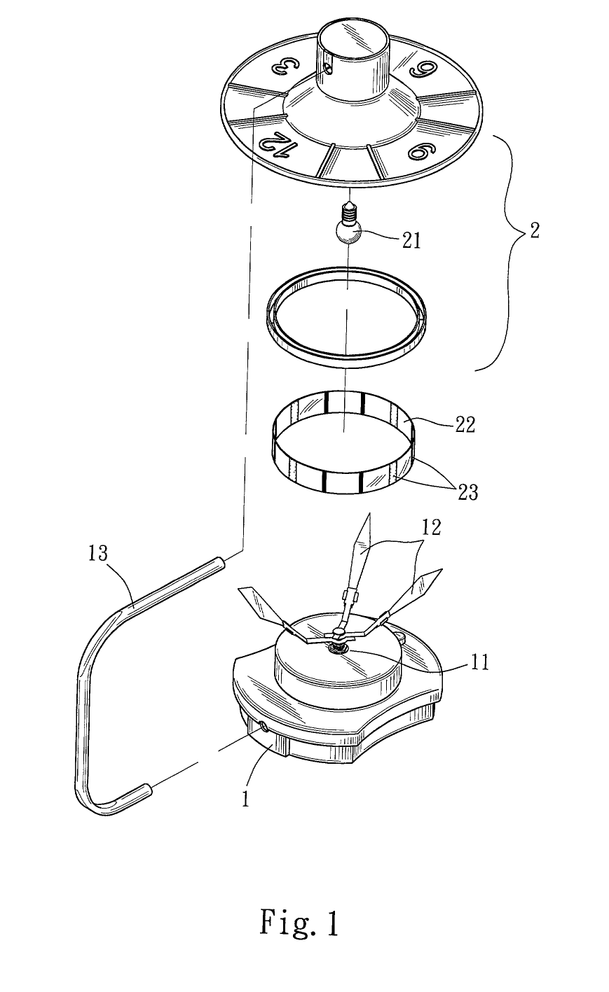

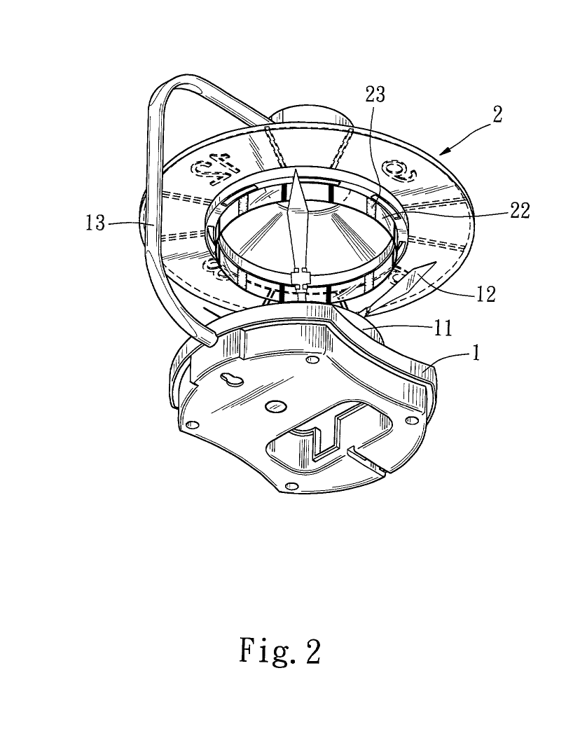

Please refer to FIGS. 1 and 2. The wall lamp structure with projective clock of the present invention includes a seat body 1 and a projecting unit 2. The seat body 1 has a bottom face adapted to a horizontal face or wall face 3. The other face of the seat body 1 is provided with a timer 11 having several foldable indicators 12 which are positioned above the front face of the seat body 1 and outward extend therefrom. The seat body 1 is connected with the projecting unit 2 by a connecting member 13. The projecting unit 2 is right positioned above the timer 11. The projecting unit 2 is a shade body having a cavity facing the timer 11. A light emitter 21 is disposed in the cavity. A mark member 22 having marks 23 on the circumference is fitted around the cavity and spaced from the light emitter 21 by a certain distance. The mark member 22 is made of transparent or semitransparent material. In use, the light emitter 21 of the projecting unit 2 projects light bean onto the mark member 22 and the indicators 12 of the timer 11. Accordingly, the shades 231, 121 of the marks 23 of the mark member 22 and the indicators 12 are shown on the wall face 3 to form a magnified shade-type clock. A user can watch such clock from a farther place. Therefore, the wall lamp not only serves to create a romantic effect, but also provides a unique shade-type clock.

The above embodiment is only used to illustrate the present invention, not intended to limit the scope thereof. Many modifications of the above embodiments can be made without departing from the spirit of the present invention.

What is claimed is:

1. Wall lamp structure with projective clock, comprising a seat body for mounting on a wall face and a projecting unit, a timer being disposed on the seat body, the timer having several indicators which are positioned above a front face of the seat body and outward extend therefrom, the seat body being connected with the projecting unit by a connecting member, the projecting unit being right positioned above the front face of the seat body, the projecting unit being a shade body, a light emitter being disposed in the projecting unit and facing the front face of the seat body, a mark member having marks being annularly disposed and spaced from the light emitter by a certain distance, whereby, the light emitter projects light beam onto the mark member and the indicators of the timer to show the shades thereof on the wall face.

2. Wall lamp structure with projective clock as claimed in claim 1, wherein one face of the projecting unit facing the timer is formed with a cavity in which the light emitter is disposed, the mark member being fitted around the cavity.

3. Wall lamp structure with projective clock as claimed in claim 1, wherein the mark member is made of transparent or semitransparent material.
